(19) United States
(12) Patent Application Publication
(10) Pub. No.: US 2017/0080688 A1
(43) Pub. Date: Mar. 23, 2017

(54) LAYERED GLASSY PHOTOSENSITIVE ARTICLE AND METHOD OF MAKING

(71) Applicant: Corning Incorporated, Corning, NY (US)

(72) Inventors: Nicholas Francis Borrelli, Elmira, NY (US); Joseph Michael Matusick, Corning, NY (US); Joseph Francis Schroeder III, Corning, NY (US); Natesan Venkataraman, Painted Post, NY (US)

(73) Assignee: Corning Incorporated, Corning, NY (US)

(21) Appl. No.: 15/119,923

(22) PCT Filed: Feb. 19, 2015
(86) PCT No.: PCT/US2015/016472

§ 371 Date: Aug. 18, 2016

Related U.S. Application Data
(60) Provisional application No. 61/943,091, filed on Feb. 21, 2014.

(51) Int. Cl. B32B 17/06; C03C 4/04; C03B 17/04; C03B 17/06; C03B 17/02; C03C 23/00; C03C 3/112; C03C 21/00

(52) U.S. Cl. CPC B32B 17/06; C03C 3/112; C03C 4/04; C03C 21/002; C03B 17/064; C03B 17/02; C03C 21/005; C03C 23/002; C03B 17/04; C03C 2204/00; B32B 2457/20; B32B 2307/412

(57) ABSTRACT

A method includes forming a glassy article. The glassy article includes a first glassy layer and a second glassy layer adjacent to the first glassy layer. The second glassy layer includes a photosensitive glass. The glassy article is exposed to radiation to form an exposed glassy article. The exposed glassy article is subjected to a heat treatment, whereby a plurality of inclusions is formed in the photosensitive glass of the second glassy layer.

This application claims the benefit of priority to U.S. Provisional Application No. 61/943091 filed on Feb. 21, 2014 the content of which is incorporated herein by reference in its entirety.

### BACKGROUND

1. Field

This disclosure relates to glassy articles. More particularly, this disclosure relates to photosensitive glassy articles.

2. Technical Background

Photosensitive glass generally includes photosensitive metal ions. Exposing the photosensitive glass to radiation frees electrons within the photosensitive glass. The freed electrons can be released from sensitizer ions present in the photosensitive glass. The photosensitive metal ions trap the freed electrons and are reduced to form metal particles. The photosensitive glass can be heated to cause the reduced metal ions to coalesce. The metal particles can serve as nucleating agents to promote the formation of crystallites in the photosensitive glass, such as characteristic of a glass-ceramic.

### SUMMARY

Disclosed herein are methods of forming a photosensitive glassy article. The glassy article comprises a first glassy layer and a second glassy layer adjacent to the first glassy layer. The second glassy layer comprises a photosensitive glass. The glassy article is exposed to radiation to form an exposed glassy article. The exposed glassy article is subjected to a heat treatment, whereby a plurality of inclusions is formed in the photosensitive glass of the second glassy layer.

Also disclosed herein is a glassy article comprising a first cladding layer, a second cladding layer, and a core layer disposed between the first cladding layer and the second cladding layer. At least one of the first cladding layer or the second cladding layer comprises a photosensitive glass. The photosensitive glass comprises a plurality of inclusions therein.

Also disclosed herein is a glassy article comprising a first glass layer and a second glass layer adjacent to the first glass layer. The second glass layer comprises a photosensitive glass. A plurality of inclusions is formable in the second glass layer in response to exposure of the glassy article to radiation followed by a heat treatment.

Additional features and advantages will be set forth in the detailed description which follows, and in part will be readily apparent to those skilled in the art from that description or recognized by practicing the embodiments as described herein, including the detailed description which follows, the claims, as well as the appended drawings.

It is to be understood that both the foregoing general description and the following detailed description are merely exemplary, and are intended to provide an overview or framework to understanding the nature and character of the claims. The accompanying drawings are included to provide a further understanding, and are incorporated in and constitute a part of this specification. The drawings illustrate one or more embodiment(s), and together with the description serve to explain principles and operation of the various embodiments.

### BRIEF DESCRIPTION OF THE DRAWINGS

FIG. 1 is a cross-sectional view of one exemplary embodiment of a glassy article.

FIG. 2 is a cross-sectional view of one exemplary embodiment of an overflow distributor apparatus.

FIG. 3 is a face view of the glassy article shown in FIG. 1.

FIG. 4 is an edge view of the glassy article shown in FIG. 1.

FIG. 5 illustrates one exemplary embodiment of a method for forming a plurality of inclusions in the glassy article shown in FIG. 1.

FIG. 6 is a cross-sectional view of another exemplary embodiment of a glassy article.

FIG. 7 is a plot of furnace temperature vs. time during a heat treatment process for producing the glass cane of Example 1.

FIG. 8 is a photograph of an edge-lit glass cane produced according to Example 1.

FIG. 9 is a photograph of an edge-lit glass cane produced according to Example 2.

FIG. 10 is a photograph of an edge-lit glass cane produced according to the Comparative Example.

### DETAILED DESCRIPTION

Reference will now be made in detail to exemplary embodiments which are illustrated in the accompanying drawings. Whenever possible, the same reference numerals will be used throughout the drawings to refer to the same or like parts. The components in the drawings are not necessarily to scale, emphasis instead being placed upon illustrating the principles of the exemplary embodiments.

As used herein, the term “photosensitive glass” refers to a glass that can undergo a transformation in response to exposure to radiation, such as at least a portion of the glass being transformed into glass-ceramic. Examples of photosensitive glass include, but are not limited to, photoreactive glass and photorefractive glass. The transformation can be manifest, for example, by opalization, by a change in refractive index, or by a change in absorption spectrum of electromagnetic radiation (e.g., a change in color). In some embodiments, the radiation comprises ultraviolet (UV) radiation. In some embodiments, the exposure to radiation is followed by a development treatment (e.g., a heat treatment) to aid in bringing about the transformation of the glass. In some embodiments, exposure of the photosensitive glass to the radiation followed by the development treatment causes opalization of the exposed portion of the photosensitive glass. Throughout this disclosure, the term “photosensitive glass” is used to refer to the material in either the untransformed state (i.e., prior to exposure to radiation and/or development treatment) or the transformed state (i.e., after exposure to radiation and/or development treatment).

As used herein, the term “average coefficient of thermal expansion” refers to the average coefficient of thermal expansion of a given material or layer between 0° C. and 300° C.

In various embodiments, a layered glassy article comprises at least a first glassy layer and a second glassy layer. For example, the first glassy layer is a core layer, and the second glassy layer is a cladding layer adjacent to the core layer. The first glassy layer and the second glassy layer are glassy layers, each comprising a glass, a glass-ceramic, or a combination thereof. In some embodiments, the first glassy layer and/or the second glassy layer are transparent glassy layers. Additionally, or alternatively, the second glassy layer (e.g., the one or more cladding layers) comprises a photosensitive glass. A plurality of inclusions is formed and/or formable in the photosensitive glass as described herein. In some embodiments, the inclusions comprise regions of the second glassy layer having a different phase than the glass matrix of the second glassy layer surrounding the inclusions (e.g., crystallized regions dispersed within the glass matrix). Additionally, or alternatively, the inclusions comprise regions of the second glassy layer with a refractive index that is different than the refractive index of the glass matrix of the second glassy layer surrounding the inclusions. The inclusions can scatter light within the second glassy layer. In some embodiments, the plurality of inclusions comprises a determined pattern to enable scattered light to be emitted from the glassy article in a desired emission profile as described herein.

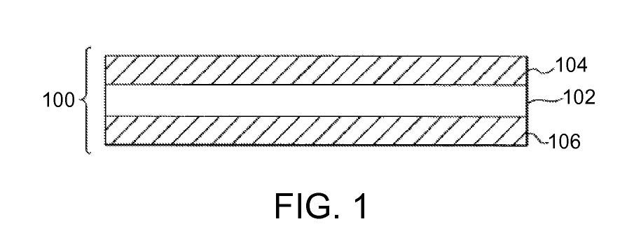

FIG. 1 is a cross-sectional view of one exemplary embodiment of a glassy article 100. In some embodiments, glassy article 100 comprises a laminated sheet comprising a plurality of glassy layers. The laminated sheet can be substantially planar as shown in FIG. 1 or non-planar. For example, a planar laminated sheet can be formed into a non-planar, 3 -dimensional shape using an appropriate forming process. Glassy article 100 comprises a core layer 102 disposed between a first cladding layer 104 and a second cladding layer 106. In some embodiments, first cladding layer 104 and second cladding layer 106 are exterior layers as shown in FIG. 1. In other embodiments, the first cladding layer and/or the second cladding layer are intermediate layers disposed between the core layer and an exterior layer.

Core layer 102 comprises a first major surface and a second major surface opposite the first major surface. In some embodiments, first cladding layer 104 is fused to the first major surface of core layer 102. Additionally, or alternatively, second cladding layer 106 is fused to the second major surface of core layer 102. In such embodiments, the interfaces between first cladding layer 104 and core layer 102 and/or between second cladding layer 106 and core layer 102 are free of any bonding material such as, for example, an adhesive, a coating layer, or any non-glass material added or configured to adhere the respective cladding layers to the core layer. Thus, first cladding layer 104 and/or second cladding layer 106 are fused directly to core layer 102 or are directly adjacent to core layer 102 to form a glass-glass laminate. In some embodiments, the glassy article comprises one or more intermediate layers disposed between the core layer and the first cladding layer and/or between the core layer and the second cladding layer. For example, the intermediate layers comprise intermediate glass layers and/or diffusions layers formed at the interface of the core layer and the cladding layer.

In some embodiments, core layer 102 comprises a first glass composition, and first and/or second cladding layers 104 and 106 comprise a second glass composition that is different than the first glass composition. For example, in the embodiment shown in FIG. 1, core layer 102 comprises the first glass composition, and each of first cladding layer 104 and second cladding layer 106 comprises the second glass composition. In other embodiments, the first cladding layer comprises the second glass composition, and the second cladding layer comprises a third glass composition that is different than the first glass composition and/or the second glass composition.

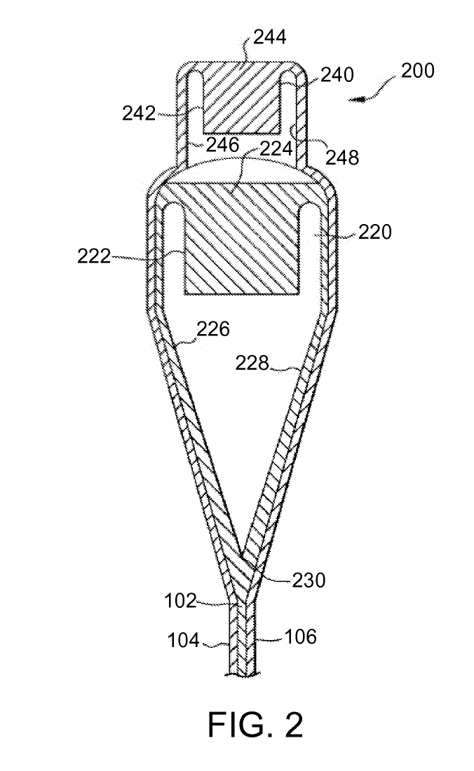

The glassy article can be formed using an appropriate process such as, for example, a fusion draw, down draw, slot draw, up draw, or float process. In some embodiments, the glassy article is formed using a fusion draw process. FIG. 2 is a cross-sectional view of one exemplary embodiment of an overflow distributor 200 that can be used to form a glassy article such as, for example, glassy article 100. Overflow distributor 200 can be configured as described in U.S. Pat. No. 4,214,886, which is incorporated herein by reference in its entirety. For example, overflow distributor 200 comprises a lower overflow distributor 220 and an upper overflow distributor 240 positioned above the lower overflow distributor. Lower overflow distributor 220 comprises a trough 222. A first glass composition 224 is melted and fed into trough 222 in a viscous state. First glass composition 224 forms core layer 102 of glassy article 100 as further described below. Upper overflow distributor 240 comprises a trough 242. A second glass composition 244 is melted and fed into trough 242 in a viscous state. Second glass composition 244 forms first and second cladding layers 104 and 106 of glassy article 100 as further described below.

First glass composition 224 overflows trough 222 and flows down opposing outer forming surfaces 226 and 228 of lower overflow distributor 220. Outer forming surfaces 226 and 228 converge at a draw line 230. The separate streams of first glass composition 224 flowing down respective outer forming surfaces 226 and 228 of lower overflow distributor 220 converge at draw line 230 where they are fused together to form core layer 102 of glassy article 100.

Second glass composition 244 overflows trough 242 and flows down opposing outer forming surfaces 246 and 248 of upper overflow distributor 240. Second glass composition 244 is deflected outward by upper overflow distributor 240 such that the second glass composition flows around lower overflow distributor 220 and contacts first glass composition 224 flowing over outer forming surfaces 226 and 228 of the lower overflow distributor. The separate streams of second glass composition 244 are fused to the respective separate streams of first glass composition 224 flowing down respective outer forming surfaces 226 and 228 of lower overflow distributor 220. Upon convergence of the streams of first glass composition 224 at draw line 230, second glass composition 244 forms first and second cladding layers 104 and 106 of glassy article 100.

In some embodiments, second glass composition 244 comprises a photosensitive glass. Thus, a plurality of inclusions can be formed in first and second cladding layers 104 and 106 as described herein. Additionally, or alternatively, first glass composition 224 comprises a non-photosensitive glass, such as a glass that does not undergo a transformation in response to exposure to radiation.

In some embodiments, first glass composition 224 of core layer 102 in the viscous state is contacted with second glass composition 244 of first and second cladding layers 104 and 106 in the viscous state to form the laminated sheet. In some of such embodiments, the laminated sheet is part of a glass ribbon traveling away from draw line 230 of lower overflow distributor 220 as shown in FIG. 2. The glass ribbon can be drawn away from lower overflow distributor 220 by an appropriate means including, for example, gravity and/or pulling rollers. The glass ribbon cools as it travels away from lower overflow distributor 220. The glass ribbon is severed to separate the laminated sheet therefrom. Thus, the laminated sheet is cut from the glass ribbon. The glass ribbon can be severed using an appropriate technique such as, for example, scoring, bending, thermally shocking, and/or laser cutting. In some embodiments, glassy article 100 comprises the laminated sheet as shown in FIG. 1. In other embodiments, the laminated sheet can be processed further (e.g., by cutting or molding) to form glassy article 100.

Although glassy article 100 shown in FIG. 1 comprises three layers, other embodiments are included in this disclosure. In other embodiments, a glassy article can have a different number of layers, such as two, four, or more layers. For example, a glassy article comprising two layers can be formed using two overflow distributors positioned so that the two layers are joined while traveling away from the respective draw lines of the overflow distributors or using a single overflow distributor with a divided trough so that two glass compositions flow over opposing outer forming surfaces of the overflow distributor and converge at the draw line of the overflow distributor. A glassy article comprising four or more layers can be formed using additional overflow distributors and/or using overflow distributors with divided troughs. Thus, a glassy article having a select number of layers can be formed by modifying the overflow distributor accordingly.

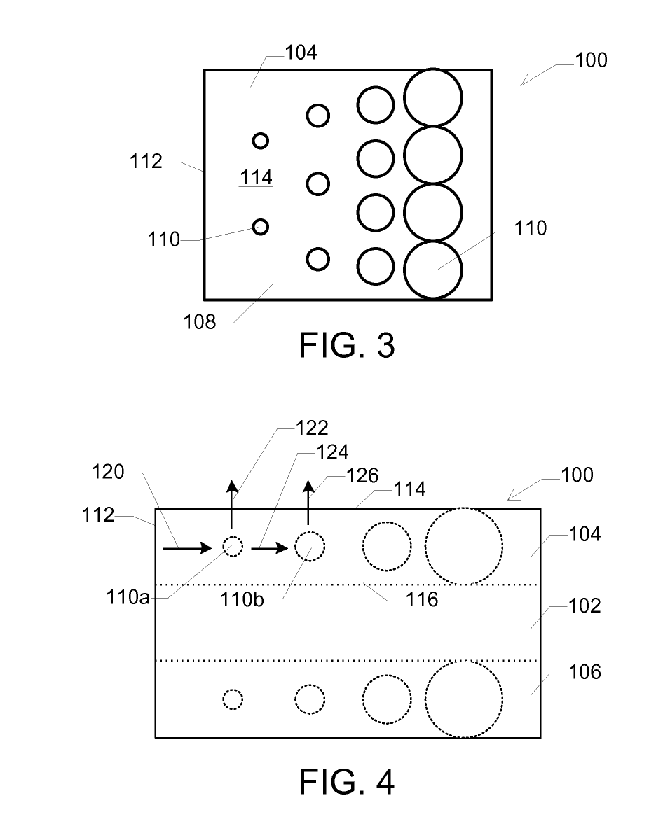

FIG. 3 shows a face view of first cladding layer 104 of glassy article 100 shown in FIG. 1. In some embodiments, first cladding layer 104 comprises a photosensitive glass 108. For example, the second glass composition of first cladding layer 104 comprises photosensitive glass 108. In some embodiments, first cladding layer 104 comprises a plurality of inclusions 110 dispersed within photosensitive glass 108. Inclusions 110 can be formed using an appropriate technique such as, for example, exposing glassy article 100 to radiation and/or subjecting glassy article 100 to a development treatment as described herein. Inclusions 110 comprise regions of first cladding layer 104 with a phase and/or a refractive index that is different than that of the glass matrix of photosensitive glass 108 surrounding the inclusions. In some embodiments, inclusions 110 comprise metal particles and/or crystallites formed within photosensitive glass 108 as described herein. For example, inclusions 110 comprise scattering centers capable of scattering light within glassy article 100.

FIG. 4 shows an edge view of glassy article 100 shown in FIGS. 1 and 3. Inclusions 110 can aid in scattering light that is introduced into first cladding layer 104. For example, light can be introduced into an edge 112 of first cladding layer 104. The light propagates through the glass matrix of first cladding layer 104 from edge 112 and contacts inclusions 110. Upon contacting inclusions 110, the light is scattered. At least a portion of the scattered light is directed out of first cladding layer 104. For example, first cladding layer 104 comprises a first face 114 and a second face 116 opposite the first face as shown in FIGS. 3-4. At least a portion of the scattered light is emitted from first face 114 and/or second face 116 of first cladding layer 104.

In some embodiments, the plurality of inclusions 110 comprises a pattern. For example, a size, a pitch, and/or an inclusion density of inclusions 110 vary along at least one dimension of glassy article 100. In the embodiment shown in FIGS. 3-4, the size, the pitch, and the inclusion density of inclusions 110 vary along a length of glassy article 100 in a direction away from edge 112. Inclusions 110 are increasingly larger along the length of glassy article 100 in the direction away from edge 112. The pitch or spacing between adjacent inclusions 110 is increasingly smaller along the length of glassy article 100 in the direction away from edge 112. The inclusion density or number of inclusions 110 per unit volume is increasingly larger along the length of glassy article 100 in the direction away from edge 112. The decreasing pitch can be a result, for example, of the increasing size of the inclusions and/or the increasing inclusion density.

Although inclusions 110 shown in FIGS. 3-4 are spherical, other embodiments are disclosed herein. In other embodiments, the inclusions can have another regular or irregular shape including, for example, ellipsoid, prismatic, or plate-like shapes. Additionally, or alternatively, larger inclusions can comprise aggregates of smaller inclusions. For example, relatively small inclusions can be disposed in close proximity to one another to form larger inclusions.

The pattern of the plurality of inclusions 110 can aid in controlling the scattering of light within first cladding layer 104, and thus, the emission of light from the face of the first cladding layer. The pattern of the plurality of inclusions 110 can enable control of the emission profile or the amount or intensity of light emitted at varying positions along the length and/or width of first cladding layer 104. For example, a first amount of light 120 can be introduced into edge 112 of first cladding layer 104. In some embodiments, proximal inclusions 110a positioned near edge 112 are smaller and spaced farther from one another compared to distal inclusions 110b positioned farther from the edge as shown in FIGS. 3-4. The light contacts proximal inclusions 110a. A second amount of light 122 is scattered and emitted from first cladding layer 104, and a third amount of light 124 (i.e., a remaining portion of first amount of light 120 that was not emitted from first cladding layer 104 with the second amount of light) continues to propagate through first cladding layer 104 in the direction away from edge 112. Because second amount of light 122 was emitted from first cladding layer 104 in response to contacting proximal inclusions 110a, third amount of light 124 is less than first amount of light 120 introduced into edge 112. In other words, the light propagating through first cladding layer 104 in the direction away from edge 112 is attenuated as more of the light is scattered and emitted from the first cladding layer.

The light contacts distal inclusions 110b, and a fourth amount of light 126 is scattered and emitted from first cladding layer 104. Because distal inclusions 110b are larger and closer together than proximal inclusions 110a, a proportion of third amount of light 124 that contacts distal inclusions 110b and is scattered is greater than a proportion of first amount of light 120 that contacts proximal inclusions 110a and is scattered. In other words, a ratio of fourth amount of light 126 to third amount of light 124 is greater than a ratio of second amount of light 122 to first amount of light 120. Although the amount of light propagating through first cladding layer 104 decreases along the length of glassy article 100 in the direction away from edge 112, the proportion of the propagating light that is scattered and emitted increases along the length of the glassy article in the direction away from the edge. In some embodiments, second amount of light 122 scattered by proximal inclusions 110 a is substantially the same as fourth amount of light 126 scattered by distal inclusions 110b. Thus, although less light reaches distal inclusions 110b than reaches proximal inclusions 110a, a greater proportion of the light that reaches distal inclusions 110b is scattered and emitted from glassy article 100 so that substantially the same amount of light is emitted at the positions of proximal and distal inclusions 110 a and 110b.

In some embodiments, second cladding layer 106 comprises a photosensitive glass. The photosensitive glass of second cladding layer 106 can be the same as or different than photosensitive glass 108 of first cladding layer 104. In some embodiments, second cladding layer 106 comprises a plurality of inclusions dispersed within the photosensitive glass as shown in FIG. 4. The inclusions can be formed using an appropriate technique as described herein. Additionally, or alternatively, the plurality of inclusions can comprise a pattern as described herein. The pattern of the plurality of inclusions of second cladding layer 106 can be the same as or different than the pattern of the plurality of inclusions 110 of first cladding layer 104. Thus, the light emission profile of each of the first cladding layer and the second cladding layer can be controlled substantially independently of one another.

Although the pattern of the plurality of inclusions 110 shown in FIGS. 3-4 comprises varying size, pitch, and inclusion density, other embodiments are disclosed herein. In some embodiments, the inclusion density varies along the at least one dimension of the glassy article. For example, the inclusion density varies continuously along the length of the glassy article in the direction away from the edge of the glassy article. In some embodiments, the inclusion density varies linearly along the at least one dimension of the glassy article. In other embodiments, the inclusion density varies exponentially along the at least one dimension of the glassy article. In some embodiments, the size of the inclusions is substantially constant along the at least one dimension of the glassy article while the inclusion density varies. For example, in some embodiments, the inclusions comprise dots of a halftone pattern with varying inclusion density. Additionally, or alternatively, the pitch of the inclusions varies along the at least one dimension of the glassy article while the inclusion density varies. In various embodiments, the size, pitch, or inclusion density (or some combination thereof) of the inclusions can vary or remain substantially constant along the at least one dimension of the glassy article.

The pattern of the plurality of inclusions (e.g., the size, pitch, and/or inclusion density) can be selected to control the emission profile of light emitted from the glassy article. For example, the pattern of the plurality of inclusions can be selected such that the intensity of the light emitted from the glassy article (e.g., from the first and/or second cladding layers) varies along the at least one dimension (e.g., the length and/or the width) of the glassy article. The variable light intensity can increase or decrease along the at least one dimension of the glassy article. In some embodiments, the variable light intensity can increase and decrease along different portions of the at least one dimension so that light is emitted from the glassy article in a desired pattern or character (e.g., one or more symbols, numbers, or letters). Alternatively, the pattern of the inclusions can be selected such that the intensity of the light emitted from the glassy article is substantially constant along at least one dimension of the glassy article. Thus, the light is emitted uniformly along the at least one dimension of the glassy article. For example, in some embodiments, the intensity of the light emitted from the glassy article varies by less than about 30%, less than about 20%, or less than about 10% over a distance of 15 cm along the at least one dimension of the glassy article. In some embodiments, the pattern of the plurality of inclusions comprises a diffraction grating. The diffraction grating can be used to control the diffraction of an edge launched light propagating through cladding layer.

In some embodiments, glassy article 100 comprises a thickness of at least about 0.05 mm, at least about 0.1 mm, at least about 0.2 mm, or at least about 0.3 mm. Additionally, or alternatively, glassy article 100 comprises a thickness of at most about 1.5 mm, at most about 1 mm, at most about 0.7 mm, or at most about 0.5 mm. In some embodiments, a ratio of a thickness of core layer 102 to a thickness of glassy article 100 is at least about 0.8, at least about 0.85, at least about 0.9, or at least about 0.95. Additionally, or alternatively, the ratio of the thickness of core layer 102 to the thickness of glassy article 100 is at most about 0.95, at most about 0.9, at most about 0.85, or at most about 0.8. In some embodiments, a thickness of the second glassy layer (e.g., each of first cladding layer 104 and second cladding layer 106) is from about 0.002 mm to about 0.25 mm.

In various embodiments, the photosensitive glass can comprise a glass composition that is responsive to radiation as described herein. Two exemplary photosensitive glasses that can be used in embodiments described herein are FOTALITE™ and FOTAFORM™, each from Corning Incorporated, Corning, N.Y.

In some embodiments, the photosensitive glass comprises cerium (e.g., CeO₂ and/or Ce₂O₃). For example, the photosensitive glass comprises from about 0.005 wt % to about 0.2 wt % cerium, or from about 0.01 wt % to about 0.15 wt % cerium, calculated as CeO₂. In some embodiments, the photosensitive glass comprises the cerium in the +3 oxidation state (e.g., Ce₂O₃). The cerium can serve as a sensitizer ion capable of being oxidized and releasing electrons in response to exposure of the glassy article to radiation.

In some embodiments, the photosensitive glass comprises at least one photosensitive metal selected from the group consisting of silver, gold, copper, and combinations thereof. For example, the photosensitive glass comprises from about 0.0005 wt % to about 0.2 wt % silver, or about 0.005 wt % to about 0.05 wt % silver. In some embodiments, the photosensitive glass comprises the at least one photosensitive metal in the +1 oxidation state (e.g., AgNO₃). The photosensitive metal can be reduced to form colloidal metal particles in response to exposure of the glassy article to radiation and/or subjecting the glassy article to the development treatment.

In some embodiments, the photosensitive glass comprises at least one halogen selected from the group consisting of fluorine, bromine, chlorine, and combinations thereof. For example, the photosensitive glass comprises from about 2 wt % to about 3 wt % fluorine. Additionally, or alternatively, the photosensitive glass comprises from about 0 wt % to about 2 wt % bromine. In some embodiments, the halogen is present in the photosensitive glass as a halide ion. The halogen can aid in forming microcrystals or crystallites in response to exposure of the glassy article to radiation and/or subjecting the glassy article to the development treatment.

In some embodiments, the photosensitive glass comprises an alkali metal selected from the group consisting of lithium, sodium, potassium, and combinations thereof. For example, the photosensitive glass comprises from about 0 wt % to about 20 wt % Li₂O. Additionally, or alternatively, the photosensitive glass comprises from about 0 wt % to about 30 wt % Na₂O, or from about 10 wt % to about 20 wt % Na₂O. Additionally, or alternatively, the photosensitive glass comprises from about 0 wt % to about 10 wt % K₂O, or from about 0 wt % to about 1 wt % K₂O. The alkali metal can aid in forming microcrystals or crystallites in response to exposure of the glassy article to radiation and/or subjecting the glassy article to the development treatment.

In various embodiments, the photosensitive glass can comprise additional components provided that the photosensitive glass retains its photosensitive properties. For example, in some embodiments, the photosensitive glass comprises a glass network former selected from the group consisting of SiO₂, Al₂O₃, B₂O₃, and combinations thereof. Additionally, or alternatively, the photosensitive glass comprises one or more of SnO₂, ZnO, or Sb₂O₃.

Three exemplary photosensitive glass compositions that can be used in embodiments described herein are shown in Table 1. The amounts of the various components listed in Table 1 are given in wt %.

TABLE 1
Exemplary Photosensitive Glass Compositions

| | P-1 | P-2 | P-3 |
|---|---|---|---|
| SiO₂ | 67.7 | 66.9 | 72 |
| Al₂O₃ | 7.7 | 6.5 | 6.9 |
| Na₂O | 16.3 | 16.3 | 16.3 |
| K₂O | 0 | 0.75 | 0 |
| CeO₂ | 0.1 | 0.037 | 0.05 |
| Ag | 0.03 | 0.03 | 0.01 |
| F⁻ | 2.15 | 2.5 | 2.5 |
| Br⁻ | 1.2 | 1.26 | 1.1 |
| ZnO | 4.7 | 6.5 | 5 |

In various embodiments, the first glassy layer (e.g., core layer 102) can comprise a glass composition that is compatible with the photosensitive glass of the second glassy layer (e.g., first cladding layer 104 and/or second cladding layer 106). For example, in some embodiments, the first glassy layer comprises soda lime glass.

In some embodiments, the first glass composition of the first glassy layer comprises a non-photosensitive glass. For example, the first glassy layer is substantially free of at least one of the cerium, the photosensitive metal, or the halogen. In some embodiments, the first glassy layer is substantially free of the cerium. Additionally, or alternatively, the first glassy layer is substantially free of silver, gold, and/or copper. Additionally, or alternatively, the first glassy layer is substantially free of fluorine, bromine, and/or chlorine. Because the cerium, the photosensitive metal, and the halogen tend to be relatively expensive components, restricting one or more of the cerium, the photosensitive metal, or the halogen to the second glassy layer can aid in reducing the cost of the glassy article. For example, the total amount of the cerium, the photosensitive metal, and the halogen in the glassy article can be kept relatively low by including these components only in certain layers and excluding them from other layers. Because the halogen tends to be a relatively volatile component, the amount of the halogen added to the batch may be greater than the amount of halogen present in the glassy article. Thus, restricting the halogen to the second glassy layer can aid in reducing the amount of excess halogen included in the batch to yield a glassy article having a desired amount of the halogen.

In some embodiments, glassy article 100 is formed using a fusion draw process as described herein. Conventional photosensitive glasses may be difficult or even impossible to form into single layer sheets using a fusion draw process. The difficulty can be a result, for example, of relatively low liquidus viscosity or the volatility of certain components (e.g., the halogen). The first glass composition of the first glassy layer can be selected to enable forming of glassy article 100 using the fusion draw process. For example, the first glass composition of the first glassy layer comprises a liquidus viscosity of at least about 100 kP, at least about 200 kP, or at least about 300 kP. Additionally, or alternatively, the first glass composition comprises a liquidus viscosity of at most about 2500 kP, at most about 1000 kP, or at most about 800 kP. The first glass composition that forms the first glassy layer (e.g., core layer 102) of glassy article 100 can aid in carrying the second glass composition over the overflow distributor to form the second glassy layer (e.g., first cladding layer 104 and/or second cladding layer 106). Thus, glassy article 100 can comprise a laminated sheet with one or more layers of glass material that may be difficult or even impossible to form into a single layer sheet using the fusion draw process.

In some embodiments, glassy article 100 is configured as a strengthened glassy article. For example, in some embodiments, the second glass composition of the second glassy layer (e.g., first and/or second cladding layers 104 and 106) comprises a different average coefficient of thermal expansion (CTE) than the first glass composition of the first glassy layer (e.g., core layer 102). For example, first and second cladding layers 104 and 106 are formed from a glass composition having a lower CTE than core layer 102. The mismatched CTE (i.e., the difference between the CTE of first and second cladding layers 104 and 106 and the CTE of core layer 102) results in formation of compressive stress in the cladding layers and tensile stress in the core layer upon cooling of glassy article 100.

In some embodiments, the CTE of the first glassy layer and the CTE of the second glassy layer differ by at least about 5×10⁻⁷° C.⁻¹, at least about 10×10⁻⁷° C.⁻¹, or at least about 15×10⁻⁷° C.⁻¹. Additionally, or alternatively, the CTE of the first glassy layer and the CTE of the second glassy layer differ by at most about 40×10⁻⁷° C.⁻¹, at most about 30×10⁻⁷° C.⁻¹, at most about 25×10⁻⁷° C.⁻¹, at most about 20×10⁻⁷° C.⁻¹, or at most about 15×10⁷° C.⁻¹. In some embodiments, the second glass composition of the second glassy layer comprises a CTE of at least about 75×10⁻⁷° C.⁻¹, or at least about 80×10⁻⁷° C.⁻¹. Additionally, or alternatively, the second glass composition of the second glassy layer comprises a CTE of at most about 90×10⁻⁷° C.⁻¹, or at most about 85×10⁻⁷° C.⁻¹. Additionally, or alternatively, the first glass composition of the first glassy layer comprises a CTE of at least about 85×10⁻⁷° C.⁻¹, or at least about 90×10⁻⁷° C.⁻¹. Additionally, or alternatively, the first glass composition of the first glassy layer comprises a CTE of at most about 105×10⁻⁷° C.⁻¹, or at most about 100×10⁻⁷° C.⁻¹. In some embodiments, a CTE of the first glassy layer and a CTE of the second glassy layer differ from one another by at most 10%. In various embodiments, each of the first and second cladding layers, independently, can have a higher CTE, a lower CTE, or substantially the same CTE as the core layer.

In some embodiments, the second glass composition of the second glassy layer (e.g., first and/or second cladding layers 104 and 106) is ion exchangeable. For example, the second glass composition comprises alkali metal ions (e.g., Li⁺¹ or Na⁺¹) that can be exchanged with larger ions (e.g., K⁺¹ or Ag⁺¹) using an appropriate ion exchange process to form compressive stress in the second glassy layer. In some embodiments, the second glassy layer of the ion exchanged glassy article comprises a compressive layer having select depth of layer and compressive stress values.

The first glass composition of the first glassy layer (e.g., core layer 102) comprises an index of refraction n₁, and the second glass composition of the second glassy layer (e.g., first and/or second cladding layers 104 and 106) comprises an index of refraction n₂. In some embodiments, n₁ is substantially the same as n₂. In other embodiments, n₁ and n₂ differ from one another. The difference between n₁ and n₂ can aid in controlling the emission of light from the glassy article (e.g., by controlling the amount of refraction at the interfaces between the first and second glassy layers).

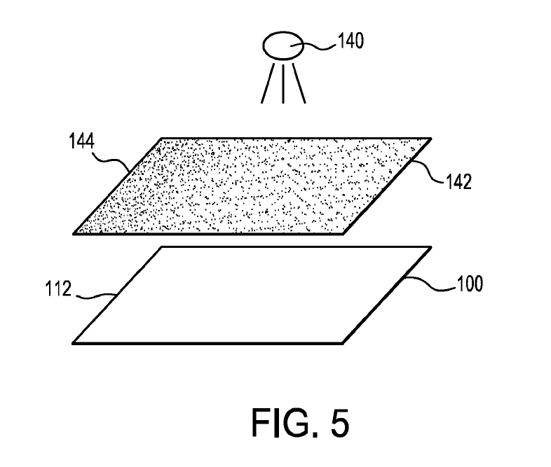

In some embodiments, the glassy article is exposed to radiation to form the plurality of inclusions therein. FIG. 5 shows one exemplary embodiment of a method for forming inclusions 110 in glassy article 100. Glassy article 100 is exposed to radiation emitted from a radiation source 140. The radiation is capable of provoking a response from the photosensitive glass. For example, in some embodiments, the radiation comprises ultraviolet (UV) radiation having a wavelength from about 10 nm to about 400 nm. Radiation source 140 can comprise a source of radiation including, for example, a lamp (e.g., a mercury xenon lamp) or the sun. In some embodiments, the exposure time can depend on the thicknesses of the first cladding layer 104 and/or the second cladding layer 106 of glassy article 100. For example, a shorter exposure time can be sufficient to form inclusions 110 in a thinner photosensitive glass layer compared to a thicker photosensitive glass layer. Thus, the exposure time can be reduced by providing the glassy article with a thinner photosensitive glass layer.

In some embodiments, a mask 142 is positioned between radiation source 140 and glassy article 100. Mask 142 comprises an opaque region that is opaque to the radiation and a transparent region that is transparent to the radiation. The opaque region of mask 142 blocks (e.g., absorbs and/or reflects) the radiation to form an unexposed region of glassy article 100. The transparent region of mask 142 transmits the radiation to form an exposed region of glassy article 100. Thus, the unexposed region of glassy article 100 is shielded from the radiation, and the exposed region of the glassy article is exposed to the radiation. Inclusions 110 are formed in the exposed region of glassy article 100 in response to exposure to the radiation. For example, at least one of first cladding layer 104 or second cladding layer 106 comprises the photosensitive glass so that inclusions 110 are formed in the respective cladding layer in response to exposure of glassy article 100 to the radiation. In some embodiments, the unexposed region of glassy article 100 is substantially free of inclusions.

In some embodiments, the transparent region of mask 142 comprises a pattern corresponding to the pattern of the plurality of inclusions 110 formed in the photosensitive glass of glassy article 100. For example, the transparent region of mask 142 comprises a plurality of openings in the opaque region of the mask. The plurality of openings comprises a gradient in at least one of a size of the openings, a pitch of the openings, or an opening density along at least one dimension (e.g., a length and/or a width) of mask 142. In other words, at least one of the size, the pitch, or the opening density varies along the at least one dimension of mask 142. For example, the pitch and/or the opening density of the plurality of openings increases along the length of mask 142 in a direction away from an edge 144 of the mask. Thus, mask 142 comprises increasingly more transparent area along the length of the mask in the direction away from edge 144 as shown in FIG. 5. In other embodiments, the size, the pitch, and/or the opening density of the plurality of openings of the mask can increase, decrease, or remain substantially constant along the at least one dimension of the mask. In some embodiments, the openings of mask 142 comprise dots of a halftone pattern. The dots are increasingly closer together and/or increasingly more dense along the length of the mask to form the gradient or pattern. In some embodiments, the transparent area of mask 142 increases exponentially along the length of the mask in the direction away from edge 144. In other embodiments, the transparent area of the mask increases in another manner (e.g., linearly) along the length of the mask in the direction away from edge 144. The pattern of the plurality of openings in mask 142 corresponds to the pattern of the plurality of inclusions 110 formed in glassy article 100.

In some embodiments, mask 142 is formed using a photolithography process. In some embodiments, mask 142 comprises a glass substrate and a metal layer disposed on a surface of the glass substrate. The metal layer can comprise a metallic material that absorbs and/or reflects the radiation including, for example, chromium. A photoresist layer is deposited on the metal layer. The photoresist layer is exposed to a pattern of light corresponding to the pattern of the opaque region (e.g., when a negative photoresist is used) or the transparent region (e.g., when a positive photoresist is used) of mask 142. The photoresist layer is developed to remove a portion of the photoresist layer corresponding to the transparent region of mask 142. Thus, the remaining portion of the photoresist layer covers the portion of the metal layer corresponding to the opaque region of mask 142. The metal layer is exposed to an etchant to remove the portion of the metal layer that is uncovered by the photoresist layer. The portion of the metal layer that is covered by the photoresist layer is protected from the etchant. Thus, the openings are formed in the metal layer to form the transparent region of mask 142. The remaining photoresist is removed.

In some embodiments, the exposed portion of glassy article 100 is exposed to the radiation to form inclusions 110 as described herein. For example, the radiation passes through the transparent region of mask 142 and contacts the exposed portion of glassy article 100. Inclusions 110 can comprise metal particles. For example, in some embodiments, the photosensitive metal of the photosensitive glass is reduced in the exposed portion of glassy article 100 in response to exposure to the radiation.

In some embodiments, exposed glassy article 100 is subjected to a development process. For example, the development process comprises a heat treatment. In some embodiments, the heat treatment comprises heating the exposed glassy article 100 to a nucleation temperature of the photosensitive glass. The nucleation temperature is the temperature at which the metal particles can be formed and/or coalesce within the exposed portion of glassy article 100. Additionally, or alternatively, the exposed glassy article is heated further to a growth temperature of the photosensitive glass. The growth temperature is the temperature at which crystallites can be formed on the metal particles within the exposed portion of glassy article 100. Thus, in some embodiments, inclusions 110 comprise metal particles serving as nucleating agents with crystallites formed thereon. The crystallites can comprise the halide and/or the alkali metal of the photosensitive glass. In some embodiments, the photosensitive glass is opalized in the exposed portion of glassy article 100 (e.g., due to the formation of the metal particles and/or the crystallites in the photosensitive glass). In some embodiments, the nucleation temperature is between about 500° C. and about 540° C., or between about 510° C. and about 530° C. Additionally, or alternatively, glassy article is heated to the nucleation temperature at a rate of between about 2° C./min and about 10° C./min, or between about 4° C./min and about 8° C./min. Additionally, or alternatively, the growth temperature is between about 570° C. and about 610° C., or between about 580° C. and about 600° C. The growth temperature can be greater than the nucleation temperature. In some embodiments, glassy article 100 is held at the nucleation temperature and/or the growth temperature for about 15 min to about 45 min.

In some embodiments, one face of the glassy article (e.g., first cladding layer 104) is exposed to radiation and then another face of the glassy article (e.g., second cladding layer 106) is exposed to radiation. In other embodiments, two faces (e.g., first cladding layer 104 and second cladding layer 106) are exposed to the radiation concurrently with one another. For example, in some embodiments, glassy article 100 is positioned between multiple sources of radiation and/or multiple masks.

Although FIG. 5 describes forming the pattern of the plurality of inclusions using mask 142, other embodiments are included in this disclosure. For example, in some embodiments, the pattern is formed by selectively focusing the radiation onto the exposed portion of the glassy article without exposing the unexposed portion of the glassy article. Such focused exposure of the glassy article can be accomplished, for example, using a digital light processing (DLP) system to control the pattern in which the radiation is directed toward the glassy article. In other embodiments, the pattern is formed by subjecting different portions of the glassy article to different heat treatments. For example, substantially all or a portion of the glassy article can be exposed to radiation, and the exposed glassy article can be passed through a furnace at varying rates so that different portions of the glassy article remain in the furnace for different periods of time. Additionally, or alternatively, the furnace can comprise a thermal gradient so that different portions of the glassy article are exposed to different temperatures within the furnace. By subjecting the glassy article to varying heat treatment along at least one dimension thereof, the properties of the inclusions can be varied along the at least one dimension to form the pattern.

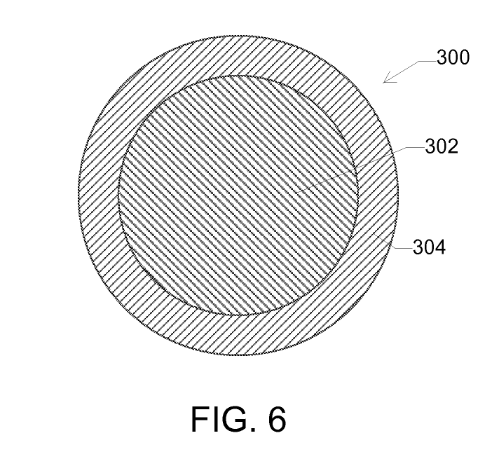

FIG. 6 is a transverse cross-sectional view of one exemplary embodiment of a glassy article 300. Glassy article 300 comprises at least a first glassy layer and a second glassy layer. In some embodiments, glassy article 300 comprises a laminated rod or cane comprising a plurality of glass layers. The laminated rod can be substantially cylindrical as shown in FIG. 6 or non-cylindrical. For example, a cross-section of the laminated rod can be circular, elliptical, triangular, rectangular, or another polygonal or non-polygonal shape. The first glassy layer of glassy article 300 comprises a core layer 302. The second glassy layer of glassy article 300 comprises a cladding layer 304 about core layer 302. In some embodiments, cladding layer 304 is an exterior layer as shown in FIG. 6. In other embodiments, the cladding layer is an intermediate layer disposed between the core layer and an exterior layer.

In some embodiments, cladding layer 304 is fused to an outer surface of core layer 302. In such embodiments, the interface between cladding layer 304 and core layer 302 is free of any bonding material. Thus, cladding layer 304 is fused directly to core layer 302 or is directly adjacent to core layer 302 as described herein with reference to glassy article 100. In some embodiments, the glassy article comprises one or more intermediate layers disposed between the core layer and the cladding layer.

Glassy article 300 can be formed using a process such as, for example, a draw process (e.g., double crucible draw) or an extrusion process. In some embodiments, glassy article 300 is formed using a draw process.

In some embodiments, core layer 302 comprises a first glass composition, and cladding layer 304 comprises a second glass composition that is different than the first glass composition. In some embodiments, cladding layer 304 comprises a photosensitive glass. Additionally, or alternatively, core layer 302 comprises a non-photosensitive glass. In some embodiments, cladding layer 304 comprises a plurality of inclusions dispersed within the photosensitive glass. The inclusions can be formed using an appropriate technique as described herein with reference to glassy article 100. The inclusions can aid in scattering light that is introduced into cladding layer 304 (e.g., into an end of the cladding layer). The light propagates through the glass matrix of cladding layer 304, contacts the inclusions, and is scattered. At least a portion of the scattered light is directed out of cladding layer 304.

In some embodiments, the plurality of inclusions comprises a pattern. For example, the size, pitch, and/or inclusion density of the plurality of inclusions vary along at least one dimension (e.g., a length and/or a circumference) of glassy article 300. The plurality of inclusions can comprise a pattern as described herein with reference to glassy article 100. The pattern can be selected to control the emission of light from glassy article 300. For example, the pattern can be selected such that the intensity of the light emitted from glassy article 300 varies along the at least one dimension (e.g., the length and/or the circumference) of the glassy article. Alternatively, the pattern can be selected such that the intensity of the light emitted from glassy article 300 is substantially constant along the at least one dimension of the glassy article.

Although glassy articles 100 and 300 are described herein as comprising the photosensitive glass in cladding layers, other embodiments are included in this disclosure. For example, in other embodiments, the core layer comprises the photosensitive glass. Additionally, or alternatively, the cladding layers comprise non-photosensitive glass. In various embodiments, any of the various layers can comprise a photosensitive glass or a non-photosensitive glass to form a glassy article having desirable light emission properties.

In embodiments described herein, the glassy article can be used for a variety of applications including, for example, for cover glass or glass backplane applications in consumer or commercial electronic devices including, for example, LCD and LED displays, computer monitors, and automated teller machines (ATMs); for touch screen or touch sensor applications; for portable electronic devices including, for example, mobile telephones, personal media players, and tablet computers; for photovoltaic applications; for architectural glass applications; for automotive or vehicular glass applications; for commercial or household appliance applications; for solid state lighting applications including, for example, luminaires for LED lamps; or for photobioreactor applications.

In some embodiments, a transparent display comprises a glassy article as described herein. For example, the glassy article can be used as a transparent backlight of a transparent display. Light can be introduced into an edge and emitted from a face of the glassy article as described herein to provide backlight functionality. Also for example, the glassy article can be used as a screen for a transparent projection display. An image projected onto the glassy article can be visible to a viewer (e.g., as a result of the scattering centers present in the glassy article). For transparent display applications, the glassy article can be configured as a glassy sheet (e.g., as described herein with reference to FIG. 1). Additionally, or alternatively, the glassy article can be substantially transparent to visible light. For example, the glassy article transmits at least about 80%, at least about 90%, or at least about 95% of visible light.

### EXAMPLES

Various embodiments will be further clarified by the following examples.

### Example 1

A substantially cylindrical laminated cane (similar to glassy article 300 shown in FIG. 6) was formed using a double crucible draw of non-photosensitive soda lime glass for the core and photosensitive glass for the clad. The photosensitive glass had the composition P-1 shown in Table 1 above. The cane had a diameter of about 2-3 mm. The clad had a thickness of about 30-100 μm. The clad thickness was varied during the draw.

The cane was exposed to the radiation generated by a 1 kW HgXe flood lamp set at an output of 10 mW/cm². The cane was exposed for 75 s, rotated 90° about its longitudinal axis and exposed for an additional 75 s, rotated another 90° about its longitudinal axis and exposed for an additional 75 s, and rotated another 90° about its longitudinal axis and exposed for an additional 75 s. Thus, each quarter of the cane surface was exposed to the radiation for about 75 s.

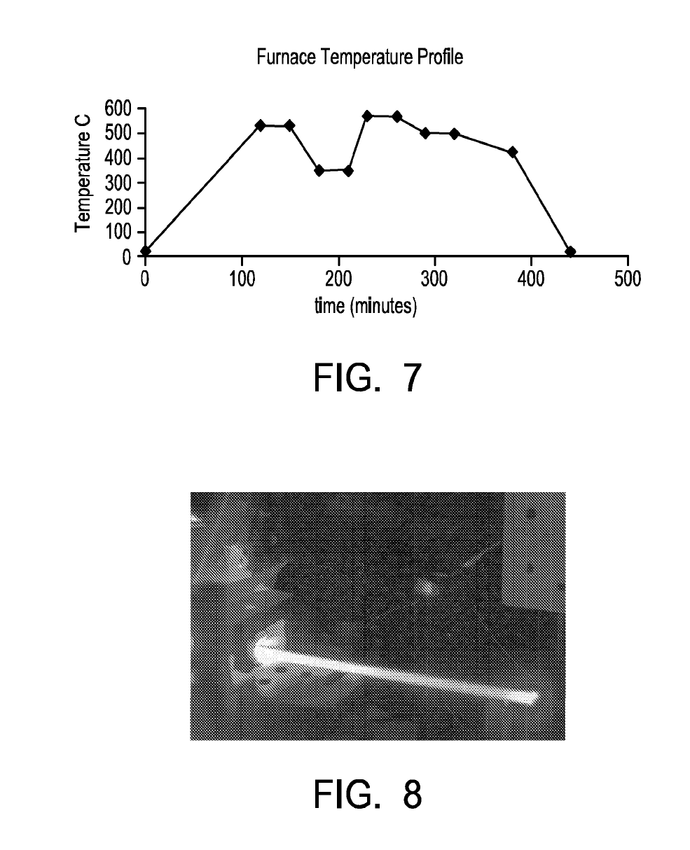

The exposed cane was subjected to a heat treatment process. The cane was placed in a furnace, and the temperature of the furnace was varied over time. FIG. 7 shows the furnace temperature as a function of time during the heat treatment process.

The cane was edge lit using a blue LED, and the scattering of the light was observed visually. FIG. 8 is a photograph showing the scattering of light from the edge-lit cane. As shown in FIG. 8, there was a significant scattering from the clad. Because the entire surface of the cane was exposed to substantially the same amount of radiation, the scattering center density was uniform along the length of the cane. Thus, significantly more light was scattered in the proximal section of the cane closer to the edge-lit end than in the distal section of the cane farther from the edge-lit end as shown in FIG. 8.

### Example 2

A laminated cane was formed using the same procedure as described in Example 1. However, during exposure of the cane, a gradient mask was positioned between the flood lamp and the cane. The transparent area of the gradient mask increased along the length of the mask so that the area of the exposed portion of the outer surface of the cane increased along the length of the cane.

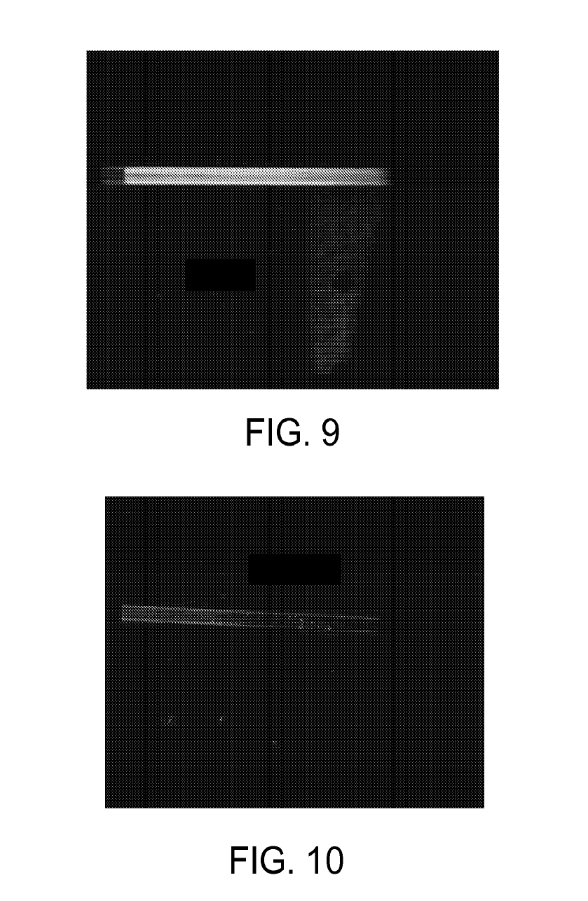

The cane was edge lit using a blue LED, and the scattering of the light was observed visually. FIG. 9 is a photograph showing the scattering of light from the edge-lit cane. Because an increasingly greater area of the surface of the cane was exposed to radiation along the length of the cane, the scattering center density increased along the length of the cane. Thus, the amount of light scattered in the proximal section of the cane closer to the edge-lit end was similar to the amount of light scattered in the distal section of the cane farther from the edge-lit end as shown in FIG. 9. Thus, the light emission profile of the cane can be controlled by selectively exposing the exposed portions of the cane and shielding the unexposed portions of the cane to distribute the scattering centers in a desired manner.

### Comparative Example

A laminated cane was formed using the same procedure as described in Example 1. However, the cane was not exposed to the radiation or subjected to the heat treatment process.

The cane was edge lit using a blue LED, and the scattering of the light was observed visually. FIG. 10 is a photograph showing the scattering of light from the edge-lit cane. The lack of light scattering indicates the lack of scattering centers formed in the cane.

It will be apparent to those skilled in the art that various modifications and variations can be made without departing from the spirit or scope of the invention. Accordingly, the invention is not to be restricted except in light of the attached claims and their equivalents.

1. A method comprising:
forming a glassy article comprising a first glassy layer and a second glassy layer adjacent to the first glassy layer, the second glassy layer comprising a photosensitive glass;
exposing the glassy article to radiation to form an exposed glassy article; and
subjecting the exposed glassy article to a heat treatment such that a plurality of inclusions is formed in the photosensitive glass of the second glassy layer, the plurality of inclusion comprising a determined pattern to control an emission profile of light emitted from the glassy article.

2. (canceled)

3. The method of claim 1, wherein the exposing the glassy article to radiation comprises exposing an exposed portion of the second glassy layer comprising the determined pattern to the radiation without exposing an unexposed portion of the second glassy layer to the radiation.

4. The method of claim 3, wherein:
the exposing the glassy article to radiation comprises positioning a mask between a radiation source and the glassy article and
the mask comprises an opaque region that blocks the radiation and a transparent region that transmits the radiation
the opaque region of the mask comprises a pattern corresponding to the unexposed portion of the second glassy layer of the glassy article and shields the unexposed portion from exposure to the radiation; and
the transparent region of the mask comprises a plurality of openings in the opaque region of the mask.

5-6. (canceled)

7. The method of claim 4, wherein the plurality of openings comprises a gradient in at least one of a size of the openings, a pitch of the openings, or a density of the openings along at least one dimension of the mask.

8. The method of claim 1, wherein the photosensitive glass comprises cerium and at least one photosensitive metal selected from the group consisting of silver, gold, copper, and combinations thereof.

9. (canceled)

10. The method of claim 1, wherein the first glassy layer comprises a non-photosensitive glass.

11. (canceled)

12. The method of claim 1, wherein:
a thickness of the glassy article is from about 0.05 mm to about 1.5 mm; and
a thickness of the second glassy layer is from about 0.002 mm to about 0.25 mm.

13. (canceled)

14. The method of claim 1, further comprising subjecting the glassy article to an ion exchange treatment.

15. A glassy article comprising:
a first cladding layer;
a second cladding layer; and
a core layer disposed between the first cladding layer and the second cladding layer;
wherein at least one of the first cladding layer or the second cladding layer comprises a photosensitive glass, the photosensitive glass comprises a plurality of inclusions therein, and the inclusions comprise metal particles dispersed in the photosensitive glass in a determined pattern, whereby light scattered by the plurality of inclusions is emitted from the glassy article in an emission profile resulting from the determined pattern.

16. The glassy article of claim 15, wherein each of the first cladding layer and the second cladding layer comprises the photosensitive glass.

17. The glassy article of claim 15 or claim 16, wherein the photosensitive glass comprises:
cerium
at least one photosensitive metal selected from the group consisting of silver, gold, copper, and combinations thereof; and
at least one halogen selected from the group consisting of fluorine, bromine, chlorine, and combinations thereof.

18. (canceled)

19. The glassy article of claim 15, wherein the core layer comprises a non-photosensitive glass.

20. (canceled)

21. The glassy article of claim 15, wherein at least one of a size of the inclusions, a pitch of the inclusions, or a density of the inclusions varies along at least one dimension of the glassy article.

22. The glassy article of claim 15, wherein an intensity of light emitted from a surface of the glassy article in response to introduction of light into an edge of the glassy article varies by less than about 30% over a distance of 15 cm along at least one dimension of the glassy article in a direction away from the edge.

23. The glassy article of claim 15, wherein:
a thickness of the glassy article is from about 0.05 mm to about 1.5 mm; and
a ratio of a thickness of the core layer to the thickness of the glassy article is at least about 0.8.

24. (canceled)

25. The glassy article of claim 15, wherein a coefficient of thermal expansion (CTE) of each of the first cladding layer and the second cladding layer is less than a CTE of the core layer.

26. The glassy article of claim 15, wherein each of the first cladding layer and the second cladding layer is ion exchanged.

27-37. (canceled)

38. A consumer or commercial electronic device, a touch screen or touch sensor, a portable electronic device, a photovoltaic device, an architectural glass, an automotive or vehicular glass, a commercial or household appliance, a solid state lighting device, or a photobioreactor comprising the glassy article of claim 15.

39. A transparent display comprising the glassy article of claim 15.

40. The method of claim 4, wherein the plurality of openings of the transparent region comprises a halftone pattern.

41. The glassy article of claim 15, wherein the determined pattern comprises a halftone pattern.
